(19) United States
(12) Patent Application Publication
(10) Pub. No.: US 2007/0125770 A1
(43) Pub. Date: Jun. 7, 2007

(54) HEATING APPARATUS

(75) Inventor: Maki HAMAGUCHI, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/555,940

(22) Filed: Nov. 2, 2006

(30) Foreign Application Priority Data
Dec. 6, 2005 (JP) 2005-352608

(51) Int. Cl. H05B 6/26; H05B 6/10

(52) U.S. Cl. 219/651; 219/635

(57) ABSTRACT

Disclosed herein is a heating apparatus designed to heat an object to be heated through induction heat generation of a heat generating part made of glasslike carbon, and that can rapidly raise or lower the temperature without contamination of the object which has a large area and is formed into a shape of a substrate such as a silicon wafer. The heating apparatus includes a heating container for receiving the object. The container is constructed such that at least a portion of the container formed into a shape of a plate is made of glasslike carbon, and that the portion of the container serves as a heat generating part. A high-frequency plate-shaped coil is disposed at the outside of the container while the coil is adjacent and is opposed to the heat generating part of the container, and which is wound approximately into a shape of a plate. The heating apparatus further includes a container-inside gas atmosphere control means for controlling the inside of the container to be maintained at a predetermined gas atmosphere. When electric current is supplied to the coil, heat is generated from the heat generating part through induction heat generation of the heat generating part, whereby the object is heated.

### BACKGROUND OF THE INVENTION

1. Field of the Invention

The present invention relates to a heating apparatus used for heat treatment in the process for manufacturing a semiconductor integrated circuit. In particular, this invention relates to the heating apparatus that is designed to heat an object to be heated through induction heat generation of a heat generating part made of glasslike carbon and that can rapidly raise or lower the temperature without contamination of the object which has a large area and is formed into a shape of a substrate such as a silicon wafer.

2. Description of the Related Art

In order to heat an object to be heated disposed in a predetermined gas atmosphere, there is generally used a combination comprising at least two components, i.e., a heating container which receives the object and maintains the interior of the container to the above-mentioned gas atmosphere, and a heating means for heating the object as well as the container. The container is usually made of a material having high heat resistance and high airtightness, such as quartz, various kinds of ceramic, or metal. As the heating means, a resistance heat generation type heater, an infrared lamp, or a set of a high-frequency coil (a high-frequency induction heating coil) and a susceptor which surrounds the container and generates heat through induction, is used.

However, the above-described combination has a problem in that the container has a certain heat insulation effect and therefore, is not necessarily suitable for a method of rapidly raising the temperature of the object, and heating the object in a very short period of time and then instantly lowering the temperature of the object.

One means for solving the above-mentioned problems is to use glasslike carbon as the material of the container and the induction heat generating part. The glasslike carbon is suitably used in the above-described case because glasslike carbon is a material having high airtightness and high induction heat generation efficiency.

For example, Non-Patent Document 1 discloses a method of generating heat from a cylindrical body made of glasslike carbon through induction heat generation of the cylindrical body. Specifically, a cylindrical high-frequency coil is disposed around the cylindrical body, constructed by winding a coil along the outer circumference of the cylindrical body. When high-frequency current is supplied to the coil, heat is generated from the cylindrical body through induction heat generation. According to this method, it is possible to manufacture a heating apparatus that can accomplish the above-mentioned purpose by adding a means for controlling a gas atmosphere in the cylindrical body.

The method of generating heat from the cylindrical body through induction heat generation is suitable to heat the object in a relatively small quantity. When the object has a large area and is formed into a shape of a substrate (a plate) such as a silicon wafer with a relatively large diameter, however, it is necessary to prepare a fairly large cylindrical body. As a result, it is difficult to accomplish satisfactory heating efficiency and uniform heating of the object. Consequently, the method of generating heat from the cylindrical body through induction heat generation is not suitable to heat the object having a large area.

On the other hand, there is well known a heating apparatus for heating a silicon wafer as shown in FIG. 4. FIG. 4 illustrates the structure of a typical single-wafer type vapor-phase epitaxial growth system having a high-frequency coil as a heating apparatus.

As shown in FIG. 4, a disc-shaped susceptor 73 made of graphite is disposed in a reaction container 71 made of quartz such that silicon wafers 72 are loaded on the susceptor 73 one by one. Below the susceptor 73 at the outside of the reaction container 71 is disposed a high-frequency coil 74 wound into a shape of a plate for heating the silicon wafer 72 through induction heat generation of the susceptor 73, which supports the silicon wafer 72. A source gas (reaction gas) is introduced into the reaction container 71 through a gas inlet port 75, flows along the surface of the silicon wafer 72 approximately into a shape of a laminar flow, and is discharged from the reaction container 71 through a gas outlet port 76 on the opposite side of the gas inlet port 75. In this vapor-phase epitaxial growth system, a silicon epitaxial layer is formed by vapor-phase growth while the silicon wafer 72 is heated to a predetermined temperature level through induction heat generation of the susceptor 73 using the high-frequency coil 74.

Specifically, the plate-shaped susceptor 73 made of graphite is disposed in the reaction container 71, the high-frequency coil 74 is disposed at the outside of the reaction container 71 such that the high-frequency coil 74 is adjacent to the susceptor 73, and induction heat generation of the susceptor 73 is performed to heat the silicon wafer 72 loaded on the susceptor 73. This system is suitable to rapidly increase the temperature of the silicon wafer 72. However, the susceptor 73 and the silicon wafer 72 are in contact with each other, which may cause a relatively large temperature fluctuation in the wafer and contamination of the wafer. Furthermore, since the reaction container has a certain heat insulation effect, it is difficult to rapidly decrease the temperature of the silicon wafer 72.

[Patent Document 1] Japanese Unexamined Patent Publication No. 2003-151737 (Columns 2-6, FIG. 1) [Non-Patent Document 1] J. H. Fisher, L. R. Holland, G. M. Jenkins, and H. Maleki “A new process for the production of long glassy polymeric carbon hollow ware with uniform wall thickness using a spray technique” in Carbon, vol. 34, No. 6, pp. 789-795, 1996

### SUMMARY OF THE INVENTION

Therefore, the present invention has been made in view of the above problems, and it is an object of the present invention to provide a heating apparatus that is so designed as to heat an object to be heated which has a large area and is formed into a shape of a substrate such as a silicon wafer through induction heat generation of a heat generating part made of glasslike carbon and that can rapidly raise or lower the temperature without contamination of the object.

In accordance with the present invention, the above and other objects can be accomplished by the provision of a heating apparatus comprising: according to a first aspect of the invention, a heating container for receiving an object to be heated, the container being constructed such that at least a portion of the container, which is formed so as to have a planar outer part, is made of glasslike carbon, and the portion of the container serves as a heat generating part; a high-frequency plate-shaped coil disposed at the outside of the container while the coil is adjacent and opposed to the heat generating part of the container, and is wound approximately into a shape of a plate; and a container-inside gas atmosphere control means for controlling the inside of the container to be maintained at a predetermined gas atmosphere, wherein, when electric current is supplied to the coil, heat is generated from the heat generating part through induction heat generation, whereby the object is heated.

According to a second aspect of the invention, in the heating apparatus of the first aspect, the object is formed into a shape of a substrate.

According to a third aspect of the invention, the heating apparatus of the first or the second aspect further comprises: a container-outside gas atmosphere control means for controlling the outside of the container to be maintained at a predetermined gas atmosphere.

According to a fourth aspect of the invention, the heating apparatus of any one of the first to third aspects further comprises: a heat insulation member and/or a reflection member disposed between the heat generating part and the coil.

According to a fifth aspect of the invention, in the heating apparatus of any one of the first to the fourth aspects, the ratio (R2/R1) of the emissivity (R2) of the inner surface of the heat generating part to the emissivity (R1) of the outer surface of the heat generating part is 1.2 or more.

The heating apparatus according to the present invention includes a heating container for receiving an object to be heated. The container is constructed such that at least a portion of the container, specifically, a portion approximately formed into a shape of a plate, is made of glasslike carbon, and the plate-shaped portion of the container serves as a heat generating part. The heating apparatus further includes a high-frequency plate-shaped coil, which is disposed at the outside of the container while the coil is adjacent and is opposed to the heat generating part of the container. The coil is wound approximately into a shape of a plate. Consequently, when electric current is supplied to the coil, heat can be generated from the heat generating part with good heat distribution through induction heat generation of the heat generating part. As a result, it is possible to emit heat to the object which has a large area and is formed into a shape of a substrate (a plate) such as a silicon wafer with high directivity, and therefore, to rapidly raise the temperature of the object, whereby the object is rapidly heated. In addition, the heat generating part is made of glasslike carbon, which does not generate any gaseous contaminant or dust even at high temperature, and has even high chemical resistance, while the remaining part of the container except for the heat generating part does not generate heat. Consequently, it is possible to heat the object without contaminating the object. Since the heat generating part is made of glasslike carbon, which has a small heat capacity, after the heat treatment, the heat generating part can be easily cooled by an appropriate means such as blowing cooling nitrogen gas to the heat generating part, and therefore, it is possible to rapidly lower the temperature of the object in the container.

The heating apparatus according to the present invention further includes a container-outside gas atmosphere control means for controlling the outside of the container to be maintained at an inert gas atmosphere. Consequently, it is possible to prevent the oxidative degradation of the heat generating part made of glasslike carbon even at relatively high temperature.

The heating apparatus according to the present invention further includes a heat insulation member and/or a reflection member disposed between the heat generating part and the coil. Consequently, it is possible to greatly reduce the temperature-raising time of the object, and therefore, to greatly increase the heating efficiency. Also, the effect is accomplished only by the heat generating part without the entirety of the heating apparatus being covered, and therefore, even the temperature-lowering speed can be secured.

Furthermore, in the case of the heating apparatus wherein the ratio (R2/R1) of the emissivity (R2) of the inner surface of the heat generating part to the emissivity (R1) of the outer surface of the heat generating part is 1.2 or more, it is possible to increase the emissivity (R2) of the inner surface of the heat generating part facing the inside of the container in which the object is disposed to be greater than the emissivity (R1) of the outer surface of the heat generating part facing the outside of the container, like the above-mentioned ratio. As a result, the ratio of the heat emission from the container to the outside to the heat generated by induction heating is decreased. Consequently, it is possible to greatly reduce the temperature-raising time of the object, and therefore, to greatly increase the heating efficiency.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view schematically illustrating the structure of a heating apparatus according to a preferred embodiment of the present invention;

FIG. 2 is a sectional view schematically illustrating the structure of a heating apparatus according to another preferred embodiment of the present invention;

FIG. 3 is a sectional view schematically illustrating the structure of a heating apparatus according to yet another preferred embodiment of the present invention; and

FIG. 4 illustrates the structure of an example of a single-wafer type vapor-phase epitaxial growth system having a high-frequency coil as a heating apparatus according to a conventional art.

### DESCRIPTION OF THE PREFERRED EMBODIMENTS

Now, preferred embodiments of the present invention will be described in detail with reference to the accompanying drawings.

Glasslike carbon products are manufactured by carbonizing a green body made of thermosetting resin, such as phenolic resin. However, it is known that the moldability of the thermosetting resin is low, the volume of the thermosetting resin is greatly reduced after the carbonization, and the thermosetting resin is easily separated due to gas broken during the carbonization. As a result, it is difficult to manufacture large-sized glasslike carbon products having complicated shapes.

The heating apparatus according to the present invention is characterized in that only a portion made of glasslike carbon necessary to perform induction heat generation of a heating container for receiving an object to be heated is constructed as a heat generating part, whereby it is possible to overcome the above-described manufacturing difficulty, and, furthermore to accomplish rapid heating and rapid cooling of the object. Specifically, the entire container is not made of grasslike carbon, but only the heat generating part of the container is made of glasslike carbon, and therefore, it is possible to easily manufacture the container. Also, the remaining parts of the container excluding the heat generating part, are not exposed to such high temperature, and therefore may be made of a material which does not have properties of glasslike carbon but can be easily processed, such as metal, ceramic, glass, or quartz.

In the heating apparatus according to the present invention, a portion of the container is constructed as a heat generating part made of glasslike carbon, and the heating apparatus has a high-frequency coil, which faces the heat generating part, for performing induction heat generation. Consequently, it is possible to rapidly heat the object through rapid induction heat generation of the heat generating part. Furthermore, after the heat treatment of the object, the heat generating part is easily cooled by an appropriate means such as blowing cooling nitrogen gas to the heat generating part. Consequently, it is possible to rapidly lower the temperature of the object in the container. Furthermore, it is preferable to receive the object in the container such that the object is not in contact with the heat generating part of the container.

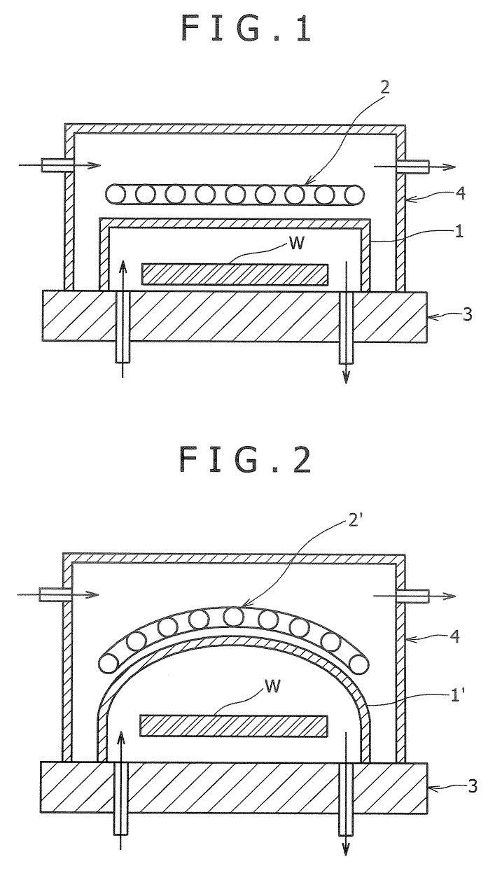

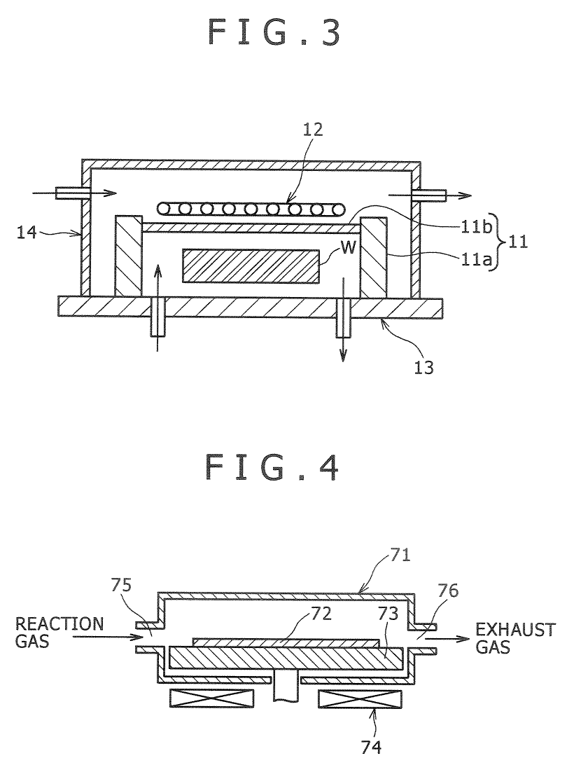

In the heating apparatus according to the present invention, the heat generating part is formed approximately into a shape of a plate, and, preferably, the ratio of the heat generating part occupying the outer surface of the container is high. Consequently, it is possible to efficiently heat the object which has a high area to weight ratio. As an example, there may be provided a dome-shaped heating container constructed such that a cylindrical body, the inner diameter of which is relatively large as compared to the length of the body, is manufactured of a material that can be easily processed as described above, such as metal or quartz, and a heat generating part comprising a disc made of glasslike carbon is mounted at an open end formed at the ceiling side of the cylindrical body, wherein the container is disposed on a manifold (a container-inside gas atmosphere control means) (see FIG. 3). As another example, there may be provided a reverse cup-shaped heating container made of glasslike carbon and constructed such that the inner diameter of a cylindrical body is relatively large as compared to the length of the body, wherein the container is disposed on a manifold (see FIGS. 1 and 2). Furthermore, a hatch (not shown) for carrying in and out the object is mounted at the manifold, on which the container is disposed.

Preferably, the heating apparatus according to the present invention is provided with a container-outside gas atmosphere control means for controlling the outside of the container to be maintained at a predetermined gas atmosphere. When glasslike carbon is exposed to a high-temperature oxidizing atmosphere, it is oxidized and degraded. For this reason, the outside of the container is maintained at an inert gas atmosphere, whereby the oxidative degradation of the heat generating part is prevented.

Preferably, the heating apparatus according to the present invention includes a heat insulation member and/or a reflection member disposed between the heat generating member and the coil. When the heat generating part emits heat through induction heat generation, on the one hand, the heat is used to heat the object; on the other hand, the heat is emitted from the container to the outside. Consequently, when the heat insulation member and/or the reflection member are disposed between the heat generating member and the coil, the heating efficiency is increased. Preferably, the heat insulation member is made of well-known heat insulating materials, such as glass fiber, carbon fiber, and ceramic. Preferably, the reflection member is made of a metal plate or a metal film.

Preferably, the heating apparatus according to the present invention is constructed such that the ratio (R2/R1) of the emissivity (R2) of the inner surface of the heat generating part to the emissivity (R1) of the outer surface of the heat generating part is 1.2 or more. Generally, carbon material is known to be a material having large emissivity. However, the inventors of the present invention have found that the emissivity of the glasslike carbon member is considerably changed depending upon its surface roughness. Specifically, the emissivity of the glasslike component is relatively low when its surface is smooth by mirror finishing, and the emissivity of the glasslike carbon component is relatively high when its surface is roughened.

Consequently, it is possible to reduce the temperature-raising time of the object, and therefore, increase the heating efficiency, by increasing the emissivity (R2) of the inner surface of the heat generating part facing the inside of the container in which the object is disposed to be greater than the emissivity (R1) of the outer surface of the heat generating part facing the outside of the container, and decreasing the ratio of heat emitted to the outside of the container, out of the heat generated by induction heat generation of the heat generating part. The reason why the above-mentioned ratio (R2/R1) is prescribed to be 1.2 or more is that, when the ratio (R2/R1) is less than 1.2, it is not possible to obtain a sufficient heating efficiency increasing effect. Furthermore, the upper limit of the emissivity of this material is 100%, and the lower limit of the emissivity of this material is 40%. Consequently, the upper limit value of the above-mentioned ratio (R2/R1) is approximately 2.5.

In the heating apparatus according to the present invention, the glasslike carbon green body constituting the heat generating part may be manufactured by forming thermosetting resin, such as phenolic resin, in a predetermined shape, heating the thermosetting resin to high temperature, for example, 1000° C. or more, in an inert gas atmosphere, and carbonizing the thermosetting resin. The thermosetting resin may be formed in the predetermined shape by a well-known process, for example, centrifugal molding, press molding, injection molding, cast molding, or bonding.

Furthermore, there is known a method of performing induction heat generation of a container which is made of glasslike carbon and is formed into a shape of a cup, such as a crucible, to heat an object to be heated (an object to be melted) in the container (for example, Japanese Unexamined Patent Publication No. 8-29066). However, this conventional method is used to uniformly heat the entirety of the container. Consequently, the entirety of the container is heated to high temperature, and therefore, it is difficult to provide a manifold for controlling an atmosphere (because of exhaustion of a sealing material). In the case that controlling the gas atmosphere in the container is necessary, the entire apparatus needs to be disposed in a predetermined gas atmosphere, whereby the size of the apparatus is inevitably increased. Also, even when the container is formed into a shape of a crucible, and induction heat generation is performed only at the bottom of the container, it is not suitable to heat the object formed into a shape of a substrate such as a silicon wafer having a large area.

### EXAMPLES

### Examples 1 and 2

FIG. 1 is a sectional view schematically illustrating the structure of a heating apparatus according to a preferred embodiment of the present invention, and FIG. 2 is a sectional view schematically illustrating the structure of a heating apparatus according to another preferred embodiment of the present invention.

Referring to FIG. 1, reference numeral 1 indicates a dome-shaped heating container which has the inner diameter greater than the length of the container, is formed in the sectional shape of a circle, and is entirely made of glasslike carbon. In the container 1 is received an object W to be heated which has a large area and is formed into a shape of a substrate (a plate) such as a silicon wafer. Reference numeral 2 indicates a high-frequency plate-shaped coil disposed at the outside of the container 1. The coil is adjacent and is opposed to a flat-shaped ceiling part of the container 1, and is wound approximately into a shape of a plate. Consequently, the ceiling part of the container 1 serves as a heat generating part.

Reference numeral 3 indicates a manifold, which is a container-inside gas atmosphere control means for supplying and discharging an inert gas, in this example, a nitrogen gas, into and from the container 1 to control the inside of the container to be maintained at a nitrogen gas atmosphere (an inert gas atmosphere). The container 1 is disposed on the manifold 3. At the manifold 3 is mounted a hatch (not shown) for carrying the object W into and from the container 1. Reference numeral 4 indicates a dome-shaped outer container also disposed on the manifold 3. The outer container 4 constitutes a container-outside gas atmosphere control means for supplying and discharging an inert gas, in this example, a nitrogen gas, to control the outside of the container 1 and the outside of the coil 2 to be maintained at a nitrogen gas atmosphere. In the outer container 4 is also mounted a cooling nitrogen gas blowing unit (not shown) for blowing a cooling nitrogen gas to the outer surface of the ceiling part (the heat generating part) of the container 1 after the heat treatment of the object W is completed.

The heating apparatus shown in FIG. 2 is identical in construction to the heating apparatus shown in FIG. 1 except that the heating apparatus shown in FIG. 2 includes a heating container 1′ and a high-frequency plate-shaped coil 2′, which are slightly different from those of the heating apparatus shown in FIG. 1. As shown in FIG. 2, the container 1′ is entirely made of glasslike carbon, and is formed into a shape of a dome having the inner diameter greater than the length of the cup. However, the ceiling part of the container 1′ is formed approximately into a shape of a dome having a slight protrusion. (The ceiling part of the container 1 shown in FIG. 1 is formed in the flat shape). The coil 2′ is also formed approximately into a shape of a dome having a slight protrusion.

Heating and cooling tests of Example 1 were carried out using the heating apparatus having the construction shown in FIG. 1, and heating and cooling tests of Example 2 were carried out using the heating apparatus having the construction shown in FIG. 2.

Hereinafter, the manufacture of the container 1 will be described. First, a commercially available liquid-phase phenolic resin (GUN EI CHEMICAL INDUSTRY COMPANY LIMITED PRODUCT NO. PL-4804) was thermally treated at 100° C. for 5 hours to control the residual solid content, and the resultant material was used as a raw material of the container 1. Subsequently, a phenolic resin container was formed by casting using a predetermined mold. The phenolic resin container was subjected to a curing treatment in which the container was heated to 200° C. for 50 hours in the air. After the curing treatment, the phenolic resin container was heated to 1000° C., at the rate of 2° C./h, in a nitrogen atmosphere, and, furthermore, the temperature was increased to 2000° C., at the rate of 10° C./h, to carbonize the phenolic resin container. As a result, a heating container 1 made of glasslike carbon and formed into a shape of a dome was manufactured. The container 1′ was also manufactured in the same process as the container 1.

As Comparative example 1, the same heating and cooling tests were carried out using a heating apparatus including a heating container made of quartz and formed into the same shape as the container 1′, used instead of the container 1′, a heating infrared lamp disposed above the dome-shaped ceiling part of the container used instead of the coil 2′, a manifold 3, and a cooling nitrogen gas blowing unit.

As Comparative example 2, the same heating and cooling tests were carried out using a heating apparatus including a heating container 1, a cylindrical high-frequency coil surrounding a body part of the container, a manifold 3, an outer container 4, and a cooling nitrogen gas blowing unit.

In the heating test, high-frequency electric power was supplied to the coil of the heating apparatus, on the conditions of a frequency of 430 kHz, an output of 1.2 kW, and an electric current of 6A, and time necessary for the temperature of the center part of the container (measured by a thermocouple) to reach 800° C. from the room temperature was measured. After the heating process was stopped, time necessary for the temperature of the center part of the container (measured by a thermocouple) to reach the room temperature from 800° C. was also measured. The results are indicated in Table 1.

TABLE 1

| | | | Comparative | Comparative |
|---|---|---|---|---|
| | Example 1 | Example 2 | example 1 | example 2 |
| Material of | Glasslike | Glasslike | Quartz | Glasslike |
| container | carbon | carbon | | carbon |
| D: Inner | 350 mm | 350 mm | 350 mm | 350 mm |
| diameter | | | | |
| L: Length of | 100 mm | 100 mm | 100 mm | 100 mm |
| body part | | | | |
| L/D | 0.29 | 0.29 | 0.29 | 0.29 |
| Shape of | Flat | Dome | Dome | Flat |
| ceiling part | | | | |
| Heating mode | High-frequency | High-frequency | Infrared lamp | High-frequency |
| | plate-shaped coil | plate-shaped coil | (Ceiling surface) | cylindrical coil |
| | (Ceiling surface) | (Ceiling surface) | | (Body part) |
| Temperature- | 20 seconds | 19 seconds | 18 seconds | 40 seconds |
| raising | | | | |
| time (Room | | | | |
| temperature to | | | | |
| 800° C.) | | | | |
| Temperature- | 25 seconds | 24 seconds | 90 seconds | 65 seconds |
| lowering time | | | | |
| (800° C. to room | | | | |
| temperature) | | | | |

In the case of Example 1 and Example 2, the temperature was raised and lowered within a very short period of time. In the case of Comparative example 1, on the other hand, the temperature was rapidly raised by infrared heating; however, the temperature-lowering speed was not satisfactorily high. In the case of Comparative example 2, the temperature-raising speed and the temperature-lowering speed were low.

### Examples 3 to 7

FIG. 3 is a sectional view schematically illustrating the structure of a heating apparatus according to yet another preferred embodiment of the present invention.

Referring to FIG. 3, reference numeral 11 indicates a dome-shaped heating container. The container 11 comprises a cylindrical body 11a of which the inner diameter is greater than the length of the cylindrical body 11a and is made of SUS316, in this example, and a circular heat generating plate (heat generating part) 11b made of glasslike carbon. The glasslike carbon heat generating plate 11b is attached to the open end of the ceiling side of the cylindrical body 11a via an O-ring for maintaining airtightness. The cylindrical body 11a has a length of 50 mm and an inner diameter of 400 mm. The heat generating plate 11b has an outer diameter of 400 mm and a thickness of 3.4 mm.

Reference numeral 12 indicates a high-frequency plate-shaped coil disposed at the outside of the container 11 while the coil 12 is adjacent and is opposed to the heat generating plate 11b of the container 11 and which is wound approximately into a shape of a plate. Consequently, the heat generating plate 11b of the container 11 serves as a heat generating part.

Reference numeral 13 indicates a manifold, which is a container-inside gas atmosphere control means for supplying or discharging an inert gas, in this example, a nitrogen gas, into or from the container 11 to control the inside of the container 11 to be maintained at a nitrogen gas atmosphere (an inert gas atmosphere). The container 11 is disposed on the manifold 13. At the manifold 13 is mounted a hatch (not shown) for carrying an object to be heated W into or out from the container 11. Reference numeral 14 indicates a container-outside gas atmosphere control means for supplying and discharging an inert gas, in this example, a nitrogen gas, into or out from the container 11 to control the outside of the container 11 (the heat generating plate 11b) and the outside of the coil 12 to be maintained at a nitrogen gas atmosphere.

Hereinafter, the manufacture of the heat generating plate 11b made of glasslike carbon will be described. First, a commercially available liquid-phase phenolic resin (GUN EI CHEMICAL INDUSTRY COMPANY LIMITED PRODUCT NO. PL-4804) was thermally treated at 100° C. for 5 hours to control the residual solid content, and the resultant material was used as a raw material of the container 11. Subsequently, a phenolic resin circular plate having an outer diameter of 500 mm and a thickness of 4 mm was formed by casting using a predetermined mold. The phenolic resin circular plate was subjected to a curing treatment in which it was heated to 200° C. for 50 hours in the air. After the curing treatment, it was heated to 1000° C., at the rate of 2° C./h, in a nitrogen atmosphere, and, furthermore, the temperature was increased to 2000° C., at the rate of 10° C./h, for carbonization. As a result, a circular heat generating plate 11b made of glasslike carbon and having an outer diameter of 400 mm and a thickness of 3.4 mm was manufactured.

Heating tests of Examples 3 to 7 and Comparative example 3 were carried out using the heating apparatus having the construction shown in FIG. 3. In the case of Example 4, however, as indicated in Table 2, a commercially available carbon fiber felt (having a thickness of 10 mm), which serves as a heat insulation member, was disposed on the outer surface of the heat generating plate 11b. Also, in the case of Example 5, an aluminum plate (having a thickness of 0.5 mm) serving as a reflection member was disposed on the outer surface of the heat generating plate 11b.

In the case of Examples 6 and 7, and Comparative example 3, the heat generating plate 11b having a roughened surface was used.

Specifically, Example 6 used the heat generating plate manufactured by carbonization, wherein its inner surface was roughened using #600 sandpaper such that its surface roughness (arithmetic mean height Ra (JIS B0601 : 2001)) was adjusted to 0.8 μm. Therefore, the emissivity (R2) of the inner surface of the heat generating plate was 49%, and the emissivity (R1) of the outer surface of the heat generating plate, which was not roughened, was 40% (surface roughness: 0.2 μm) Also, Example 7 used the heat generating plate, wherein its inner surface was roughened using #240 sandpaper such that the emissivity (R2) of the inner surface was 65% (surface roughness: 3.1 μm), and the emissivity (R1) of the outer surface of the heat generating plate, which was not roughened, was 40% (surface roughness: 0.2 μm). Comparative example 3 used the heat generating plate, wherein the inner surface of the heat generating plate was roughened using #1000 sandpaper such that the emissivity (R2) of the inner surface of the heat generating plate is 45% (surface roughness: 0.2 μm), and the emissivity (R1) of the outer surface of the heat generating plate, which is not roughened, was 40% (surface roughness: 0.2 μm).

Hereinafter, the measurement of the emissivity will be described. The emissivity was measured using JIR-5500 Type Fourier Transform Infrared Spectrometer and Infrared Radiation Measurement Unit IRR-200, which are manufactured by Japan Electron Optics Laboratory Co., Ltd, as an apparatus, and a substrate having a size of 3 cm×3 cm (in the case that the heat generating part itself cannot be mounted to the apparatus, the substrate is appropriately cut out), as a sample. The method of measuring the emissivity was carried out as follows: spectral emissive power [measurement values] of two points (160° C. and 80° C.) of a blackbody furnace and of the sample were measured; the spectral emissivity of the sample was obtained from the measured spectral emissive power and the spectral emissive power of the blackbody [theoretical value]; the integrated emissivity, as the infrared radiation, was calculated from the obtained value. The measurement conditions were as follows: the resolution was 16 cm⁻¹; the measurement temperature was 200° C. (the temperature of a sample heating stage), and the range of a wavelength was 4.5 to 15.4 μm. The measurement of the emissivity was carried out with respect to arbitrary three points of the effective heat generating area of the heat generating plate as an object to be measured, and the mean value of these three points was adopted.

In the heating test, high-frequency electric power was supplied to the coil of the heating apparatus, on the conditions of a frequency of 430 kHz, an output of 1.2 kW, and an electric current of 6A, and time necessary for the temperature of the center part of the container (measured by a thermocouple) to reach 500° C. from the room temperature was measured. The results are indicated in Table 2.

TABLE 2

| | Example | Example | Example | Comparative | Example | Example |
|---|---|---|---|---|---|---|
| | 3 | 4 | 5 | example 3 | 6 | 7 |
| Heat insulation | No | Carbon fiber | No | No | No | No |
| member | | fabrics | | | | |
| Reflection member | No | No | Aluminum | No | No | No |
| | | | plate | | | |
| Roughening of inner | No | No | No | #1000 | #600 | #240 |
| surface of heat | | | | | | |
| generating part | | | | | | |
| Emissivity (R2) of | 40% | 40% | 40% | 45% | 49% | 65% |
| inner surface | | | | | | |
| Emissivity (R1) of | 40% | 40% | 40% | 40% | 40% | 40% |
| outer surface | | | | | | |
| Ratio of | 1 | 1 | 1 | 1.125 | 1.225 | 1.625 |
| emissivities(R2/R1) | | | | | | |
| Temperature-raising | 20 | 11 | 12 | 20 | 18 | 14 |
| time (room | seconds | seconds | seconds | seconds | seconds | seconds |
| temperature to 500° C.) | | | | | | |

In the case of Example 3, as described above, the ceiling part of the container 11 was constructed using the heat generating plate 11b, and induction heat generation of the heat generating plate 11b was carried out. As a result, the temperature was raised to 500° C. in a very short period of time, 20 seconds. Also, in the case of Example 4, which further includes a heat insulation member in addition to the construction of Example 3, and Example 5, which further includes a reflection member in addition of the construction of Example 3, the temperature-raising time was further reduced.

Furthermore, in the case of Example 6 and Example 7, in which the ratio (R2/R1) of the emissivity (R2) of the inner surface of the heat generating plate lib which is the heat generating part, to the emissivity (R1) of the outer surface of the heat generating part was 1.2 or more, the temperature-raising time was further reduced as compared to Example 3, and therefore, the heating efficiency was considerably improved. In the case of Comparative example 3, on the other hand, the ratio (R2/R1) of the emissivities was less than 1.2, and therefore, the heating efficiency of Comparative example 3 was lower than that of Example 3.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A heating apparatus comprising:
a heating container for receiving an object to be heated, the container being constructed such that at least a portion of the container formed into a shape of a plate is made of glasslike carbon, and the portion of the container serves as a heat generating part;
a high-frequency plate-shaped coil disposed at the outside of the container while the coil is adjacent and is opposed to the heat generating part of the container, and which is wound approximately into a shape of a plate; and
a container-inside gas atmosphere control means for controlling the inside of the container to be maintained at a predetermined gas atmosphere, wherein
when electric current is supplied to the coil, heat is generated from the heat generating part through induction heat generation of the heat generating part, whereby the object is heated.

2. The heating apparatus according to claim 1, wherein the object is formed into a shape of a substrate.

3. The heating apparatus according to claim 1, further comprising:
a container-outside gas atmosphere control means for controlling the outside of the container to be maintained at a predetermined gas atmosphere.

4. The heating apparatus according to claim 2, further comprising:
a container-outside gas atmosphere control means for controlling the outside of the container to be maintained at a predetermined gas atmosphere.

5. The heating apparatus according to claim 1, further comprising:
a heat insulation member and/or a reflection member disposed between the heat generating part and the coil.

6. The heating apparatus according to claim 4, further comprising:
a heat insulation member and/or a reflection member disposed between the heat generating part and the coil.

7. The heating apparatus according to claim 1, wherein the ratio (R2/R1) of the emissivity (R2) of the inner surface of the heat generating part to the emissivity (R1) of the outer surface of the heat generating part is 1.2 or more.

8. The heating apparatus according to claim 6, wherein the ratio (R2/R1) of the emissivity (R2) of the inner surface of the heat generating part to the emissivity (R1) of the outer surface of the heat generating part is 1.2 or more.
